(19) United States
(12) Patent Application Publication
(10) Pub. No.: US 2012/0079587 A1
(43) Pub. Date: Mar. 29, 2012

(54) ELECTRONIC DEVICE WITH WEBCAM SECURITY FUNCTION AND METHOD THEREOF

(75) Inventor: DA-YI PENG, Tu-Cheng (TW)

(73) Assignee: HON HAI PRECISION INDUSTRY CO., LTD., Tu-Cheng (TW)

(21) Appl. No.: 12/959,291

(22) Filed: Dec. 2, 2010

(30) Foreign Application Priority Data
Sep. 27, 2010 (CN) 201010293317.0

(51) Int. Cl. G06F 12/14

(52) U.S. Cl. 726/17

(57) ABSTRACT

An electronic device with a webcam security function includes an input unit, a power supply unit, a webcam, a thin film transistor liquid crystal display (TFT-LCD) and a processing unit. The processing unit includes a receiving module, a detection module and a power control module. The receiving module receives an input operation from the input unit. The detection module detects whether the received input operation matches a predetermined input operation. The power control module controls the power supply unit to supply power to the TFT-LCD when the received input operation matches the predetermined input operation, thus enabling light to pass through the TFT-LCD to the webcam.

### BACKGROUND

1. Technical Field

The present disclosure relates to electronic devices and, particularly, to an electronic device having a webcam security function and a method for providing the function.

2. Description of Related Art

Portable computers often have built-in webcams. Unfortunately, such webcams can be hacked and user privacy violated.

### BRIEF DESCRIPTION OF THE DRAWINGS

FIG. 1 is a block diagram of a hardware infrastructure of an electronic device with webcam security function in accordance with an exemplary embodiment.

FIG. 2 shows a thin film transistor liquid crystal display (TFT-LCD) placing in front of a webcam of the electronic device of FIG. 1.

FIG. 3 is a flowchart of a method having webcam security function implemented by the electronic device of FIG. 1, in accordance with an exemplary embodiment.

### DETAILED DESCRIPTION

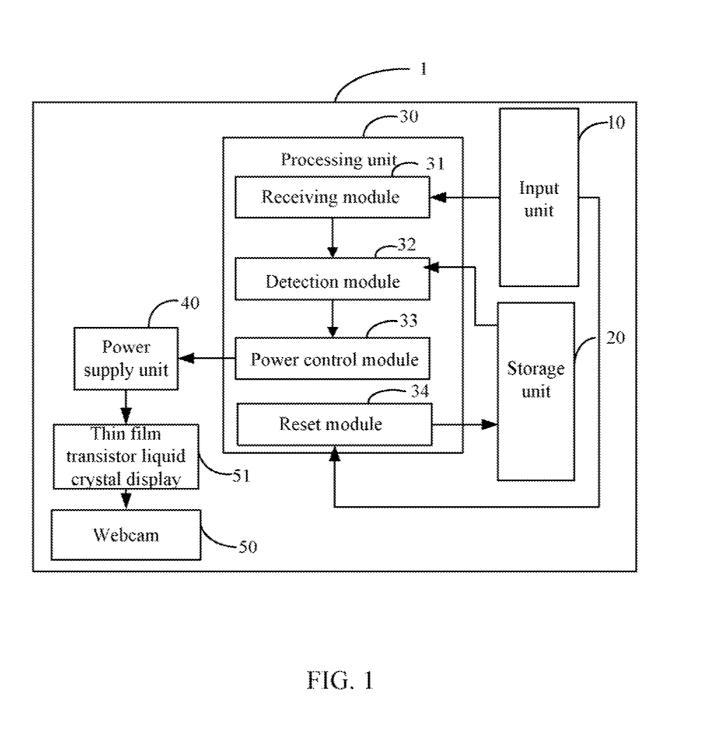

Referring to FIG. 1, an electronic device 1 with webcam security function is provided. The electronic device 1 includes an input unit 10, a storage unit 20, a power supply unit 40, a webcam 50, a thin film transistor liquid crystal display (TFT-LCD) 51 directly in front of the webcam 50, and a processing unit 30. The input unit 10 is used for receiving a user input operation. Light can only pass through the TFT-LCD 51 to the webcam 50 when it is powered on.

The processing unit 30 includes a receiving module 31, a detection module 32, and a power control module 33.

The receiving module 31 is used for receiving the input operation from the input unit 10.

The detection module 32 is used for detecting whether the input operation matches a predetermined input operation. In one embodiment, the predetermined input operation may be a predetermined password or a predetermined gesture. In other embodiments, the predetermined input operation may be a random password generated by the electronic device 1.

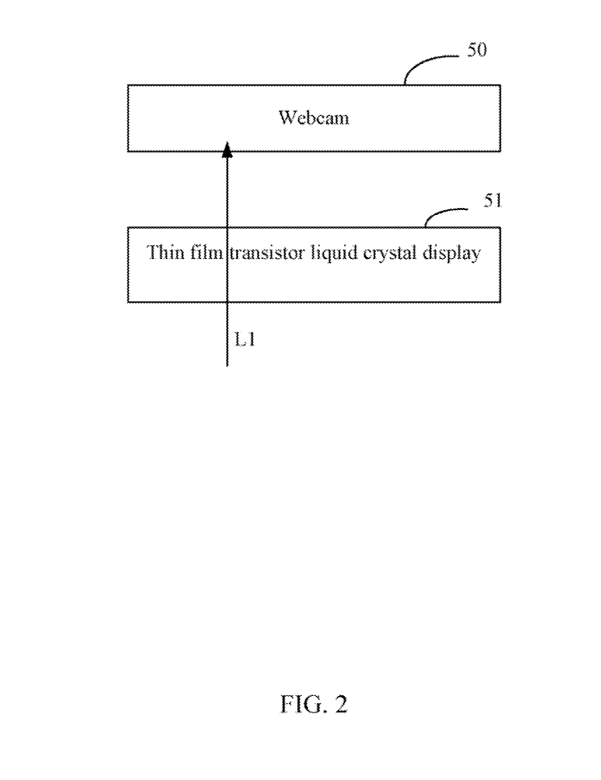

The power control module 33 is used for controlling the power supply unit 40 to supply power to the TFT-LCD 51 when the input operation matches the predetermined input operation, thus enabling light to pass through the TFT-LCD 51 to the webcam 50. As shown in FIG. 2, the TFT-LCD 51 is placed in front of the webcam 50, the light L1 passes through the TFT-LCD 51 to the webcam 50 when the TFT-LCD 51 is powered.

In another embodiment, the receiving module 31 is further used for receiving a turn-on operation from the input unit 10. The power control module 33 is further used for controlling the power supply unit 40 to turn on the webcam 50 in response to the turn-on operation. After the webcam 50 is turned on and the TFT-LCD 51 is supplied power, the webcam 50 can capture images of the area in front of the TFT-LCD 51.

In another embodiment, the processing unit 30 further includes a reset module 34. The reset module 34 is used for receiving a reset operation from the input unit 10, and resetting the predetermined input operation according to the reset operation.

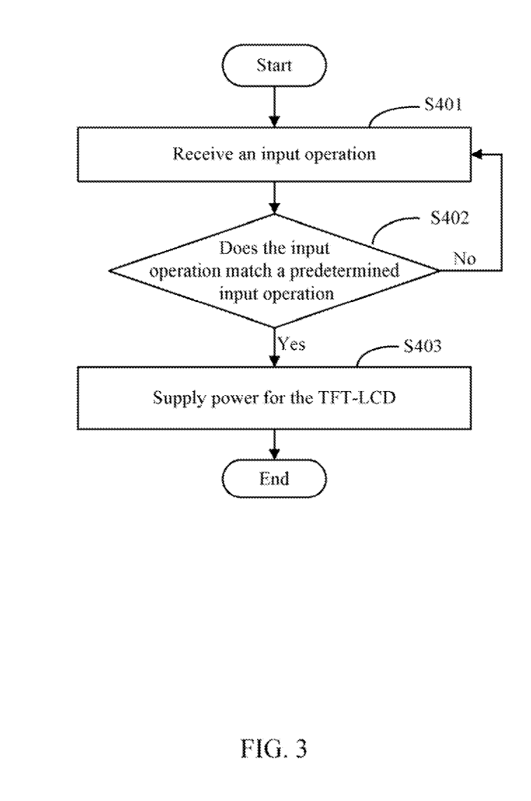

FIG. 3 is a flowchart of a method having a webcam security function implemented by the electronic device 1 of FIG. 1 in accordance with an exemplary embodiment.

In step S401, the receiving module 31 receives a user input operation from the input unit 10.

In step S402, the detection module 32 detects whether the received input operation matches the predetermined input operation, if yes, the procedure goes to step S403; if no, the procedure goes to step S401.

In step S403, the power control module 33 controls the power supply unit 40 to supply power to the TFT-LCD 51.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with a webcam security function, comprising:
an input unit for receiving an input operation;
a power supply unit;
a webcam;
a thin film transistor liquid crystal display (TFT-LCD) disposed in front of the webcam; and
a processing unit comprising:
a receiving module for receiving the input operation from the input unit;
a detection module for detecting whether the received input operation matches a predetermined input operation; and
a power control module for controlling the power supply unit to supply power to the TFT-LCD when the received input operation matches the predetermined input operation, thus enabling light to pass through the TFT-LCD to webcam.

2. The electronic device as described in claim 1, wherein the receiving module is further used for receiving a turn-on operation from the input unit, the power control module is further used for controlling the power supply unit to supply power to the webcam, thereby turning on the webcam.

3. The electronic device as described in claim 1, further comprising:
a storage unit used for storing the predetermined input operation.

4. The electronic device as described in claim 3, wherein the processing unit further comprises a reset module, the reset module is used for receiving a reset operation from the input unit, and resetting the predetermined input operation according to the reset portion.

5. The electronic device as described in claim 1, wherein the predetermined input operation is a predetermine password or a predetermined gesture.

6. The electronic device as described in claim 1, wherein the predetermined input operation is a random password generated by the electronic device.

7. A method for having a webcam security function implemented by an electronic device, wherein the electronic device comprises a power supply unit, a webcam, and a thin film transistor liquid crystal display (TFT-LCD) disposed in front of the webcam, the method comprising:
receiving an input operation;
detecting whether the received input operation matches a predetermined input operation; and
controlling the power supply unit to supply power to the TFT-LCD when the received input operation matches the predetermined input operation, thus enabling light to pass through the TFT-LCD to the webcam.

8. The method as described in claim 7, further comprising:
receiving a reset operation; and
resetting the predetermined input operation according to the reset operation.

9. The method as described in claim 7, further comprising:
receiving a turn-on operation; and
controlling the power supply unit to supply power to the webcam according to the turn-on operation, thereby turning on the webcam.
